(19) United States
(12) Patent Application Publication
(10) Pub. No.: US 2012/0232188 A1
(43) Pub. Date: Sep. 13, 2012

(54) METHOD FOR MOLDING LIQUID CRYSTAL POLYESTER RESIN COMPOSITION AND MOLDED BODY OF LIQUID CRYSTAL POLYESTER RESIN COMPOSITION

(75) Inventor: Toshio Nakayama, Chiyoda-ku (JP)

(73) Assignee: JX NIPPON OIL & ENERGY CORPORATION, Tokyo (JP)

(21) Appl. No.: 13/395,172

(22) PCT Filed: Aug. 18, 2010
(86) PCT No.: PCT/JP2010/063895

§ 371 Date: May 17, 2012

(30) Foreign Application Priority Data
Sep. 16, 2009 (JP) 2009-214880

(51) Int. Cl. B29C 45/00; C08L 67/00; C08K 3/30; C08K 3/40; C08K 3/22; C08K 3/18

(52) U.S. Cl. 523/219; 264/328.1; 524/413; 524/423; 524/599

(57) ABSTRACT

The method for molding a liquid crystal polyester resin composition according to the present invention includes molding the liquid crystal polyester resin composition by injection molding in which the resin composition is passed through a gate having a cross-sectional area of 0.05 to 1.00 mm², wherein the resin composition contains 40.0 to 70.0 parts by mass of a liquid crystal polyester (A), 29.0 to 55.0 parts by mass of an indeterminate or spherical powder (B) having a primary particle size of 0.1 to 1 μm, and 1.0 to 15.0 parts by mass of a platy, fibrous or spherical filler (C) having an average size of 20 to 300 μm, with respect to 100 parts by mass of the total amount of the resin composition.

### TECHNICAL FIELD

The present invention relates to a method for molding a liquid crystal polyester resin composition, and a molded body obtained by the molding method. Particularly, the present invention relates to a method for molding a liquid crystal polyester resin composition, in which method a molded article using a small gate cross-sectional area is injection molded.

### BACKGROUND ART

Liquid crystal polyesters are generally called melt liquid crystal type (thermotropic liquid crystal) polymers, and have remarkably excellent melt fluidity due to their peculiar behavior, and depending on their structures, exhibit a heat distortion resistance of 300° C. or higher. Making the best use of these properties, liquid crystal polyesters are used for molded bodies in applications such as electric and electronic parts as well as OA and AV parts and heat-resistant tableware. Particularly, whole aromatic thermotropic liquid crystal polyesters are known to be excellent in small-thickness moldability, heat resistance, mechanical strength, dimensional stability and the like; and since the polyesters can be adapted to soldering temperatures (about 240 to 260° C.) used in the surface mount technology (SMT), use thereof is expanding to small and thin precision parts mounted on circuit boards of electric and electronic devices such as cell phones and digital cameras in which the weight and size reduction is remarkable in recent years. These parts, partially because the melt viscosity of the liquid crystal polyesters is low, are generally produced by injection molding.

Light emitting diodes (LED) have an expanded demand as next-generation illuminations and display elements, and are utilized also as the above-mentioned electric and electronic devices. LED apparatuses are installed in the circumference of an LED element with a reflector (reflecting frame) in order to raise the light utility of the LED, and attempts have been made in which such a reflector is fabricated of a liquid crystal polyester resin composition. For example, Patent Literatures 1 to 4 propose that resin compositions containing a liquid crystal polyester and titanium oxide are injection molded to fabricate reflecting plates and reflectors. Further, since the balance between the moldability and the mechanical properties is important, for example, Patent Literature 5 proposes a resin composition in which 100 parts by weight of a liquid crystal polyester is blended with 1 to 5 parts by weight of microparticles such as silica and talc ones for the purpose of obtaining a material excellent in moldability and rigidity.

### CITATION LIST

### Patent Literature

Patent Literature 1: Japanese Patent Application Laid-Open Publication No. 2004-256673

Patent Literature 2: Japanese Patent Application Laid-Open Publication No. 2004-277539

Patent Literature 3: Japanese Patent Application Laid-Open Publication No. 2007-254669

Patent Literature 4: Japanese Patent Application Laid-Open Publication No. 2008-231368

Patent Literature 5: Japanese Patent Application Laid-Open Publication No. 2007-138143

### SUMMARY OF INVENTION

### Technical Problem

The weight and size reduction of electric and electronic devices has recently further progressed; and along with that, parts are more and more made smaller and thinner, and also the gate cross-sectional areas of molds for injection molding of the parts are made smaller. Conventional liquid crystal polyester resin compositions, although posing no problem of mold blisters even if molded bodies using a gate cross-sectional area of about 10 to 60 mm², such as test pieces (for example, ASTM test pieces) for test evaluation and flat plates, are injection molded, pose a problem of occurrence of mold blisters in molding of parts using a gate cross-sectional area of 1 mm² or smaller and decreasing the product yield. In the case of parts having thin portions whose thickness is smaller than 0.5 mm, the gate cross-sectional area is smaller than 0.1 mm² in some cases, and the problem of mold blisters is further actualized.

There are further other problems. In injection molding, an operation of separating a nozzle from a mold after batching, and an operation of bringing the nozzle into contact with the mold before injection are generally repeated. At this time, a resin leaks from the nozzle tip in the state of the nozzle being separated, in some cases (which is referred to as “drooling”). Resin compositions having a low melt viscosity and resin compositions containing a filler having a small particle size blended therein are liable to cause drooling. In the case where a liquid crystal polyester having a very low melt viscosity and a small melt tension is blended with a powder having a small primary particle size (particularly, 1 μm or smaller) of titanium oxide, silica or the like, trouble due to the above-mentioned drooling causes a problem. If drooling and mold blisters are intended to be suppressed by regulation of the molding condition, injection speed, molding temperature, the mold temperature and the like must be strictly controlled, and the range of the molding condition is remarkably narrowed, posing a difficulty in continuous molding and problems including an increased loss.

On the other hand, resin-made parts constituting cell phones, digital cameras and the like, including the above-mentioned reflector, are demanded to have sufficiently high mechanical properties, especially Izod impact strength, bending strength and deflection temperature under load (DTUL), from the viewpoint of securing the durability, the soldering heat resistance and the like.

The present invention has been achieved in consideration of the above-mentioned situation, and has an object to provide: a method for molding a liquid crystal polyester resin composition which can suppress occurrence of drooling and mold blisters of molded articles at injection molding using a small gate cross-sectional area, and can stably produce molded articles excellent in mechanical properties such as Izod impact strength, and heat resistance; and a molded body which is molded by the molding method and is excellent in mechanical properties and the like.

### Solution to Problem

As a result of exhaustive studies to solve the above-mentioned problems, the present inventers have found that by injection molding in which a resin composition containing a liquid crystal polyester, a specific powder having a specific primary particle size, and a specific filler having a specific average size in specific proportions is passed through a gate of having a cross-sectional area of 0.05 to 1.00 mm², a molded body good in Izod impact strength and excellent in mechanical properties can stably be produced while occurrence of drooling and mold blisters of molded bodies at injection molding can be suppressed; and these findings have led to the completion of the present invention.

The method for molding a liquid crystal polyester resin composition according to the present invention involves molding by injection molding in which the resin composition is passed through a gate having a cross-sectional area of 0.05 to 1.00 mm², the resin composition containing 40.0 to 70.0 parts by mass of a liquid crystal polyester (A), 29.0 to 55.0 parts by mass of an indeterminate or spherical powder (B) having a primary particle size of 0.1 to 1 μm, and 1.0 to 15.0 parts by mass of a platy, fibrous or spherical filler (C) having an average size of 20 to 300 μm, with respect to 100 parts by mass of the total amount of the resin composition.

The method for molding a liquid crystal polyester resin composition according to the present invention can sufficiently suppress occurrence of drooling and mold blisters of molded articles at molding of the molded articles using a small gate cross-sectional area, and can stably produce a molded article excellent in a mechanical property of an Izod impact strength of 30 kJ/m² or higher. The method for molding a liquid crystal polyester according to the present invention, which has such an advantage, is useful for molding precision parts of electric and electronic devices, particularly, thin molded articles having portions having a minimum thickness of smaller than 0.5 mm.

The present inventors believe that the above-mentioned advantage exhibited by the present invention is caused because blending the (A) component, the (B) component, and the (C) component in the above-mentioned proportions can improve the melt tension without damaging moldability and mechanical strength and without largely affecting the melt viscosity of a liquid crystal polyester resin composition, so that the drooling and a jetting phenomenon at injection molding can be suppressed and the occurrence of mold blisters can effectively be suppressed. By contrast, if the melt viscosity of a resin composition is raised by a method of increasing the degree of polymerization of the resin or other methods in order to increase the melt tension, since the fluidity of the resin composition decreases, in the case of injection molding using the above-mentioned gate cross-sectional area, moldability worsens including occurrence of short shot at portions having a small thickness and other portions.

If the (C) component is not blended or the blending amount of the (C) component is less than the above-mentioned lower-limit value, occurrence of drooling and mold blisters cannot be suppressed sufficiently. This is presumed to be because the melt tension at melting of a resin composition is low, drooling from an injection nozzle easily occurs and the jetting phenomenon is caused at injection molding to thereby entrain air, thus causing mold blisters. By contrast, if the blending amount of the (C) component exceeds the above-mentioned upper-limit value, the Izod impact strength remarkably decreases, making molded articles brittle.

Further in the case where the blending amounts of the (A) component and the (B) component do not satisfy the above-mentioned conditions, the suppression of drooling and the productivity cannot be secured sufficiently.

The method for molding a liquid crystal polyester resin composition according to the present invention can make the sufficient use of properties of the liquid crystal polyester, and can provide a molded body satisfying desired physical properties, such as mechanical strength, dimensional stability, heat resistance and hygroscopicity, at high levels, and imparted with properties by the (B) component and the (C) component.

In the method for molding a liquid crystal polyester resin composition according to the present invention, the (B) component is preferably at least one selected from the group consisting of titanium oxide, barium sulfate, zinc oxide, silica and barium titanate.

The (C) component is preferably at least one selected from the group consisting of talc, mica, glass fiber, carbon fiber, silica and glass balloons.

Further, the (A) component is preferably a whole aromatic thermotropic liquid crystal polyester having a melting point of 320° C. or higher.

The method for molding a liquid crystal polyester resin composition according to the present invention is preferably used for molding a thin molded article having portions having a minimum thickness of smaller than 0.5 mm.

The method for molding a liquid crystal polyester resin composition according to the present invention is preferably used for molding an LED reflector.

The present invention also provides a molded body obtained by the above-mentioned method for molding a liquid crystal polyester resin composition according to the present invention.

### Advantageous Effects of Invention

The present invention can provide a molding method for providing a molded body having excellent mechanical strengths such as

Izod impact strength by suppressing occurrence of drooling and mold blisters at injection molding using a small gate cross-sectional area while holding excellent moldability and heat resistance of a liquid crystal polyester. The molding method according to the present invention allows a stable continuous production even of a thin molded article having portions having a minimum thickness of smaller than 0.5 mm.

### Description of Embodiments

<Liquid crystal polyester (A)>

The liquid crystal polyester (hereinafter, simply abbreviated to “LCP” in some cases) according to the present invention is a polyester referred to as a thermotropic liquid crystal polymer, and forms an anisotropic melt at a temperature of 450° C. or lower. Examples of LCP include ones comprising a structural unit selected from an aromatic hydroxycarbonyl unit, an aromatic and/or aliphatic dihydroxy unit, an aromatic and/or aliphatic dicarbonyl unit, or the like. Examples of the aromatic hydroxycarbonyl unit include structural units formed from p-hydroxybenzoic acid, 6-hydroxy-2-naphthoic acid and the like; examples of the aromatic and/or aliphatic dihydroxy unit include structural units formed from 4,4′-dihydroxybiphenyl, hydroquinone, 3,3′,5,5′-tetramethyl-4,4′-dihydroxybiphenyl, tert-butylhydroquinone, phenylhydroquinone, 2,6-dihydroxynaphthalene, 2,7-dihydroxynaphthalene, 2,2-bis(4-hydroxyphenyl)propane, 4,4′-dihydroxydiphenyl ether, ethylene glycol, 1,3-propylene glycol, 1,4-butanediol and the like; and examples of the aromatic and/or an aliphatic dicarbonyl unit include structural units formed from terephthalic acid, isophthalic acid, 2,6-naphthalene dicarboxylic acid, 4,4′-diphenyldicarboxylic acid, 1,2-bis(phenoxy)ethane-4,4′-dicarboxylic acid, 1,2-bis(2-chlorophenoxy)ethane-4,4′-dicarboxylic acid, 4,4′-diphenyl ether dicarboxylic acid, adipic acid, sebacic acid and the like.

The liquid crystal polyester used in the present invention is preferably a whole aromatic thermotropic liquid crystal polyester because of being excellent in the balance between moldability, mechanical strength and heat resistance. Examples of the whole aromatic thermotropic liquid crystal polyester include one comprising a combination of an aromatic dicarboxylic acid, an aromatic diol and an aromatic hydroxycarboxylic acid, one comprising different types of aromatic hydroxycarboxylic acids, one comprising a combination of an aromatic dicarboxylic acid and an aromatic diol, and one obtained by reacting a polyester such as a polyethylene terephthalate with an aromatic hydroxylcarboxylic acid.

The whole aromatic thermotropic liquid crystal polyester used in the present invention is preferably one having a melting point of 320° C. or higher. Blending of such an LCP can more effectively achieve a molded body having thin portions which is excellent in heat resistance such as soldering resistance.

In order to obtain a whole aromatic thermotropic liquid crystal polyester having a melting point of 320° C. or higher, 40 mol % or more of p-hydroxybenzoic acid is preferably used as a raw material monomer. In addition to this, a suitable combination of other well-known aromatic hydroxylcarboxylic acids, aromatic dicarboxylic acids and aromatic dihydroxy compounds can be used. Preferable examples thereof include polyesters obtained from aromatic hydroxycarboxylic acids such as p-hydroxybenzoic acid and 6-hydroxy-2-naphthoic acid alone, and liquid crystal polyesters obtained from the aromatic hydroxycarboxylic acids and further aromatic dicarboxylic acids such as terephthalic acid, isophthalic acid and 2,6-naphthalenedicarboxylic acid and/or aromatic dihydroxy compounds such as hydroquinone, resorcin, 4,4′-dihydroxybiphenyl and 2,6-dihydroxynaphthalene.

Especially preferable is a whole aromatic thermotropic liquid crystal polyester obtained by polycondensating 80 to 100 mol % of p-hydroxybenzoic acid (a), terephthalic acid (b) and 4,4′-dihydroxybiphenyl (c) (including these derivatives) (provided the total of (a) and (b) is 60 mol % or more) with 0 to 20 mol % of another aromatic compound capable of polycondensating with one of (a), (b) and (c).

In production of a whole aromatic thermotropic liquid crystal polyester, in order to shorten the melt polycondensation time and reduce an influence of thermal history in the step, the melt polycondensation is preferably carried out after hydroxyl groups of the above-mentioned monomers are previously acetylated. In order to further simplify the step, the acetylation is preferably carried out by feeding acetic anhydride to the monomers in a reaction tank. The acetylation step is preferably carried out using the same reaction tank as the melt polycondensation step. That is, it is preferable that the raw material monomers are subjected to the acetylation reaction with acetic anhydride, and after the completion of the reaction, the temperature is raised and the acetylated monomers proceed to the polycondensation reaction.

In the case where the melt polycondensation reaction is carried out accompanied by an acetic acid-elimination reaction of the acetylated monomers, the reaction is preferably carried out using a reaction tank equipped with monomer feed means, acetic acid discharge means, melted polyester taking-out means and stirring means. Such a reaction tank (polycondensation apparatus) can suitably be selected from well-known ones. The polymerization temperature is preferably 150° C. to 350° C. After the completion of the acetylation reaction, the temperature is raised to a polymerization initiation temperature to initiate the polycondensation; and preferably, the temperature is raised in the range of 0.1° C./min to 2° C./min, and up to 280 to 350° C. as a final temperature. It is preferable that the polycondensation temperature is raised corresponding to a rise in the melting temperature of a formed polymer by the progress of the polycondensation, in such a manner. In the polycondensation reaction, a well-known catalyst can be used as a polycondensation catalyst for polyesters. The catalyst includes metallic catalysts such as magnesium acetate, stannous acetate, tetrabutyl titanate, lead acetate, sodium acetate and potassium acetate, and organic compound catalysts such as N-methylimidazole.

In the melt polycondensation, when the flow-point reaches 200° C. or higher, preferably 220° C. to 330° C., a whole aromatic thermotropic liquid crystal polyester of a low degree of polymerization is extracted as it is in the melting state from a polymerization tank, and fed to a cooler such as a steel belt or a drum cooler to cool and solidify the liquid crystal polyester.

Then, the solidified whole aromatic thermotropic liquid crystal polyester of a low degree of polymerization is ground to a size suitable for a succeeding solid-phase polycondensation. The grinding method is not especially limited, but examples thereof include impact grinding machines such as Feather Mill, Victory Mill, Coloplex, Pulverizer, Contraplex, Scroll Mill and ACM Pulverizer, made by Hosokawa Micron Corp., and Roll Granulator being a bridged cracking-type granulator, made by Matsubo Corp. Especially preferable is Feather Mill made by Hosokawa Micron Corp. In the present invention, the particle size of a ground material is not especially limited, but is preferably, in terms of industrial sieve (Tyler mesh), in the range of passing 4-mesh to not passing 2,000-mesh, more preferably 5-mesh to 2,000-mesh (0.01 to 4 mm), and most preferably 9-mesh to 1,450-mesh (0.02 to 2 mm).

Then, the ground material obtained in the grinding step is placed on a solid-phase polycondensation step to carry out solid-phase polycondensation. An apparatus and an operational condition used in the solid-phase polycondensation step are not especially limited, and a well-known apparatus and method can be used. In order to use the liquid crystal polyester as parts adapted to the surface mount technology (SMT), the solid-phase polycondensation reaction is preferably carried out until a liquid crystal polyester having a melting point of 320° C. or higher is obtained.

The content of a liquid crystal polyester (A) in a resin composition in the method for molding a liquid crystal polyester according to the present invention is 40.0 to 70.0 parts by mass, but is preferably 40.0 to 60.0 parts by mass, with respect to 100 parts by mass of the total amount of the resin composition. With the content of the liquid crystal polyester (A) of less than 40.0 parts by mass, the productivity, moldability and mechanical strength of the composition are likely to decrease; and with the content exceeding 70.0 parts by mass, since the amount of the liquid crystal polyester in the resin composition is large, the melt tension becomes small and the drooling is liable to occur, which is not preferable.

<Indeterminate or Spherical Powder (B) Having a Primary Particle Size of 0.1 to 1 μm>

In the resin composition according to the present invention, 29.0 to 55.0 parts by mass of an indeterminate or spherical powder having a primary particle size of 0.1 to 1μm is essentially blended with respect to 100 parts by mass of the total amount of the resin composition. The primary particle size refers to a number-average particle size of primary particles (particles in a minimum unit clearly separable from others). The number-average particle size is generally measured by a dynamic light scattering method, a laser light scattering method or the like.

The primary particle size of the (B) component used in the present invention is 0.1 to 1 μm, but is preferably 0.2 to 0.8 μm. By using a powder having a primary particle size in this range, the action and effect by the blending of the (B) component are sufficiently exhibited, and a molded body having high mechanical strengths such as Izod impact strength is easily obtained. A particle having a primary particle size exceeding 1 μm is likely to exhibit poor dispersibility to a liquid crystal polyester (LCP) resin, and properties imparted by blending of the (B) component, for example, in the case of an LED reflector, the reflectance decreases, which is not preferable. In the case of the primary particle size of smaller than 0.1 μm, in melting and kneading powder raw materials by an extruding machine, the powder raw materials generates faulty penetration into a screw and the extrusion amount remarkably decreases, thus reducing the productivity, which is not preferable.

Examples of the (B) component include titanium oxide, barium sulfate, silica, barium titanate, zinc oxide, glass powder, ferrite powder, aluminum oxide powder and talc. Above all, titanium oxide, barium sulfate, silica and barium titanate are preferable, and especially titanium oxide and silica are preferable.

The content of the (B) component in the resin composition according to the present invention is 29.0 to 55.0 parts by mass, but is preferably 29.0 to 50.0 parts by mass, and more preferably 40.0 to 50.0 parts by mass, with respect to 100.0 parts by mass of the total amount of the resin composition. If the content of the (B) component is less than 29.0 parts by mass, the blending amount of the (B) component such as titanium oxide and silica contained in a liquid crystal polyester composition decreases, and there arises a problem that properties imparted by blending of the (B) component, for example, in the case of an LED reflector, the reflectance decreases, which is not preferable. By contrast, if the content of the (B) component exceeds 55.0 parts by mass, the productivity and moldability of the resin composition remarkably decrease and mechanical properties remarkably decrease, which are not preferable.

<Platy, Fibrous or Spherical Filler (C) Having an Average Size of 20 to 300 μm>

In the resin composition according to the present invention, 1.0 to 15.0 parts by mass of a platy, fibrous or spherical filler (C) having an average size of 20 to 300 μm is essentially blended with respect to 100 parts by mass of the total amount of the resin composition. Here, the average size refers to a number-average particle size for a platy or spherical filler, and refers to a number-average fiber length of fibers for a fibrous filler. The average size of the (C) component in the present invention further refers to a value in a resin composition after melting and kneading. The average size of the (C) component contained in pellets of a liquid crystal polyester resin composition is determined by the following method.

Measuring method of a number-average particle size or a number-average fiber length:

About 5 g of a composition pellet is ashed in a crucible, and thereafter, 100 mg of an ash content is sampled out of the remaining ash content, and dispersed in 100 cc of soap water. One or two drops of the dispersion liquid are placed on a slide glass using a dropping pipette, and observed under a microscope and photographed. The measurement of a particle size or a fiber length of an object taken on the photograph is carried out for 500 particles or fibers, and the number-average is determined.

The average size of the (C) component used in the present invention is 20 to 300 μm, but is preferably 25 to 250 μm. In the case of the average size in this range, while the mechanical strength of an injection molded article is made sufficient, occurrence of drooling and mold blisters at injection molding can be suppressed. With the average size of the (C) component of smaller than 20 μm, it becomes difficult to suppress occurrence of drooling and mold blisters at injection molding. By contrast, if the average size of the (C) component exceeds 300 μm, the moldability remarkably decreases, particularly small-thickness moldability remarkably decreases, which is not preferable.

Examples of a platy (C) component include talc, mica, clay and glass flakes. Above all, talc and mica are preferable. Examples of a fibrous (C) component include glass fiber, carbon fiber, stainless steel fiber and wollastonite. Above all, glass fiber and carbon fiber are preferable. Examples of a spherical (C) component include silica, glass balloons and glass beads. Above all, silica and glass balloons are preferable. Among these platy, fibrous and spherical fillers, glass fiber and talc are particularly preferable from the viewpoint of being capable of obtaining high Izod impact strength and suppressing drooling and mold blisters.

The content of the (C) component in the resin composition according to the present invention is 1.0 to 15.0 parts by mass, but preferably 1.0 to 10.0 parts by mass, and more preferably 3.0 to 5.0 parts by mass, with respect to 100.0 parts by mass of the total amount of the resin composition. If the content of the (C) component is less than 1.0 part by mass, suppression of occurrence of drooling and mold blisters at injection molding becomes insufficient; and by contrast, if the content exceeds 15.0 parts by mass, the Izod impact strength decreases and the mechanical strength of molded articles becomes insufficient.

In the method for molding a liquid crystal polyester resin composition according to the present invention, one or two or more types of additives can be blended in the resin composition in the range of not damaging the object of the present invention. Examples of the additive include usual additives such as antioxidants and thermostabilizers (for example, a hindered phenol, hydroquinone, phosphites and substitution products thereof), ultraviolet absorbents (for example, resorcinol, a salicylate, benzotriazole and benzophenone), lubricants and release agents (montanic acid and a salt thereof, an ester thereof, a half ester thereof, stearyl alcohol, stearamide and polyethylene wax), plasticizers, antistatic agents and flame retardants; and other thermoplastic resins. By adding these additives, predetermined properties can be imparted to the resin composition.

In the method for molding a liquid crystal polyester resin composition according to the present invention, from the viewpoint of achieving the balance between mechanical properties, heat resistance and the like, the liquid crystal polyester resin composition preferably contains 40.0 to 50.0 parts by mass of titanium oxide as the (B) component and 3.0 to 5.0 parts by mass of glass fiber as the (C) component, with respect to 100.0 parts by mass of the total amount of the resin composition. An injection molded article obtained from such a resin composition becomes suitable for an LED reflector and the like.

<Concerning a Method for Producing a Liquid Crystal Polyester Resin Composition>

A liquid crystal polyester resin composition used in the present invention can be obtained by melting and kneading the above-mentioned each component (a liquid crystal polyester (A), an indeterminate or spherical powder (B) having a primary particle size of 0.1 to 1 μm, and a platy, fibrous or spherical filler (C) having an average size of 20 to 300 μm). As an apparatus for melting and kneading, a twin-screw kneading machine can be used. More preferable are continuous extrusion-type twin-screw kneading machines having a pair of double-flight screws, and above all, a co-rotating one which has a inverting mechanism to enable a filler to be homogeneously dispersed is preferable, and the one is preferable which has a cylinder diameter of 40 mmφ or larger having a large clearance between a barrel and the screws that makes the penetration of the filler easy, and which has a large meshing between the screws of a contact ratio of 1.45 or larger.

It is preferable that the (A) component, the (B) component, and the (C) component are mixed using a well-known solid mixing facility, for example, a ribbon blender, a tumbler blender and a Henschel mixer, and dried by a hot air drier, a reduced-pressure drier or the like according to needs, and fed from a hopper of a twin-screw kneading machine.

In production of a resin composition containing glass balloons, the blended glass balloons are preferably fed from a midway of a cylinder of a twin-screw kneading machine (so-called side-feed). Thereby, breakage of glass balloons to be filled can be suppressed more than the case where all glass balloons are fed together with other raw materials from a hopper (so-called top-feed).

The method for molding a liquid crystal polyester resin composition according to the present invention can suppress occurrence of drooling and mold blisters at injection molding using a gate cross-sectional area of 0.05 to 1.00 mm², and allows the stable continuous production of small-sized molded bodies. Precision parts of electric and electronic devices such as cell phones, in which weight and size reduction progresses in recent years, are produced by the long-time (for example, 24 hours) unmanned continuous operation of a number of injection molding machines in many cases. Therefore, if a molding machine is stopped by the cause of drooling, molding faults and the like on the way, a large loss is generated and the product yield largely decreases. According to the molding method according to the present invention, molding machines can be operated continuously for a long time stably even under the unmanned condition, and can largely improve the product yield because occurrence of mold blisters can be suppressed.

The method for molding a liquid crystal polyester resin composition according to the present invention can provide an injection molded article having an Izod impact strength of 30 kJ/m² or higher. Here, the Izod impact strength means an Izod impact strength as measured with no notch according to ASTM D256. If the Izod impact strength is lower than 30 kJ/m², the mechanical strength is insufficient for precision parts such as LED reflectors.

The method for molding a liquid crystal polyester resin composition according to the present invention can suitably be used for production of a molded body such as a precision part at least having a portion having a minimum thickness of smaller than 0.5 mm.

<Concerning the Molded Body According to the Present Invention>

The molded body according to the present invention is obtained by the above-mentioned method for molding a liquid crystal polyester resin composition according to the present invention, and can be made one in which mold blisters are sufficiently suppressed and the mechanical strength and heat resistance are sufficiently excellent. Even in the case where the molded body according to the present invention has portions having a thickness of smaller than 0.5 mm (further 0.4 mm or smaller), the molded body can concurrently exhibit a good appearance and excellent mechanical properties and heat resistance. The molded body according to the present invention can further have desired properties (for example, light reflection properties) by the (B) component and the (C) component.

The molded body according to the present invention is suitable as precision parts of electric and electronic devices such as LED reflectors.

### EXAMPLES

Hereinafter, the present invention will be described more specifically by way of Examples, but the present invention is not limited to the following Examples.

First, production examples of whole aromatic thermotropic liquid crystal polyesters (A) will be described hereinafter.

<Production Example 1: production of a whole aromatic thermotropic liquid crystal polyester (I)>

In a 1,700-L internal volume-polymerization tank (made by KOBE Steel, Ltd.) made of SUS316 as its material and having a double-helical stirring blade, 240 kg (1.74 kmol) of p-hydroxybenzoic acid (made by Ueno Fine Chemicals Industry, Ltd.), 108 kg (0.58 kmol) of 4,4′-dihydroxybiphenyl (made by Honshu Chemical Industry Co., Ltd.), 72 kg (0.44 kmol) of terephthalic acid (made by Mitsui Chemicals Inc.), 24 kg (0.15 kmol) of isophthalic acid (made by A.G. International Chemical Co., Inc.), and 0.03 kg of potassium acetate (made by Kishida Chemical Co., Ltd.) and 0.09 kg of magnesium acetate (made by Kishida Chemical Co., Ltd.) as catalysts were charged; pressure reduction-nitrogen injection of the polymerization tank was carried out twice to replace the atmosphere of the tank by nitrogen; thereafter, 311 kg (3.05 kmol) of acetic anhydride was further added; the rotation speed of the stirring blade was set at 45 rpm, and the temperature of the mixture was raised to 150° C. over 1.5 hours; and an acetylation reaction was carried out under refluxing for 2 hours.

After the completion of the acetylation, the temperature of the polymerization tank put in an acetic acid-distilling out state was raised at 0.5° C./min; and when the reactor temperature reached 310° C., a polymerized material was taken out from an extraction port at the lower part of the reactor, and cooled and solidified by a cooling apparatus. The obtained polymerized material was ground to a size passing a sieve of a sieve opening of 2.0 mm by a grinding machine, made by Hosokawa Micron Corp., to obtain a prepolymer.

Then, the obtained prepolymer was packed in a rotary kiln, made by Takasago Industry Co., Ltd.; nitrogen was circulated at a flow rate of 16 Nm³/hr; the heater temperature was raised from room temperature to 170° C. over 3 hours at a rotation speed of 2 rpm, raised to 280° C. over 5 hours, and raised further to 300° C. over 3 hours to carry out a solid-phase polycondensation. About 400 kg of a powdery whole aromatic thermotropic liquid crystal polyester (I) was thus obtained. The melting point of the obtained whole aromatic thermotropic liquid crystal polyester (I) was 352° C., and the apparent viscosity thereof at 370° C. was 70 Pa·s.

<Production Example 2: production of a whole aromatic thermotropic liquid crystal polyester (II)>

In a 1,700-L internal-volume polymerization tank (made by KOBE Steel, Ltd.) made of SUS316 as its material and having a double-helical stirring blade, 240 kg (1.74 kmol) of p-hydroxybenzoic acid (made by Ueno Fine Chemicals Industry, Ltd.), 108 kg (0.58 kmol) of 4,4′-dihydroxybiphenyl (made by Honshu Chemical Industry Co., Ltd.), 58 kg (0.35 kmol) of terephthalic acid (made by Mitsui Chemicals Inc.), 39 kg (0.23 kmol) of isophthalic acid (made by A.G. International Chemical Co., Inc.), and 0.03 kg of potassium acetate (made by Kishida Chemical Co., Ltd.) and 0.09 kg of magnesium acetate (made by Kishida Chemical Co., Ltd.) as catalysts were charged; pressure reduction-nitrogen injection of the polymerization tank was carried out twice to replace the atmosphere of the tank by nitrogen; thereafter, 311 kg (3.05 kmol) of acetic anhydride was further added; and by the same method as in the whole aromatic thermotropic liquid crystal polyester (I), a prepolymer was obtained.

The obtained prepolymer was packed in a rotary kiln, made by Takasago Industry Co., Ltd.; nitrogen was circulated at a flow rate of 16 Nm³/hr; the heater temperature was raised from room temperature to 170° C. over 3 hours at a rotation speed of 2 rpm, raised to 260° C. over 5 hours, and raised further to 290° C. over 3 hours to carry out a solid-phase polycondensation. About 400 kg of a powdery whole aromatic thermotropic liquid crystal polyester (II) was thus obtained. The melting point of the obtained whole aromatic thermotropic liquid crystal polyester (II) was 320° C., and the apparent viscosity thereof at 340° C. was 70 Pa·s.

The melting point and the apparent viscosity described above were values measured by the following methods.

[Melting Point]

The melting point of a liquid crystal polyester was measured by a differential scanning calorimeter (DSC), made by Seiko Instruments Inc., using a-alumina as its reference. At this time, the temperature was raised from room temperature to 400° C. at a temperature-rise rate of 20° C./min to completely melt the polymer; thereafter, the temperature was descended to 150° C. at a rate of 10° C./min; and a vertex of an endothermic peak acquired while the temperature was being again raised to 420° C. at a rate of 20° C./min was defined as a melting point.

[Apparent Viscosity]

The measurement of the apparent viscosity of a liquid crystal polyester used a capillary rheometer (model: 2010), made by INTESCO Co., Ltd., using a capillary of 1.0 mm in size, 40 mm in length and 90° in inflow angle. The measurement of the apparent viscosity was carried out at a shearing rate of 100 sec⁻¹ under a constant-rate heating at a temperature-rise rate of +4° C./min from a temperature 30° C. lower than the melting point measured by DSC, to determine an apparent viscosity at a predetermined temperature.

<Indeterminate or Spherical Powder (B) Having a Primary Particle Size of 0.1 to 1 μm>

As an indeterminate or spherical powder having a primary particle size of 0.1 to 1 μm, the following particle was prepared. The primary particle size described in ( ) described below was indicated as a numerical value before the particle was melted and kneaded with a liquid crystal polyester resin. Titanium oxide: trade name “SR-1”, made by Sakai Chemical Industry Co., Ltd., (primary particle size: 0.25 μm) Barium sulfate: trade name “300”, made by Sakai Chemical Industry Co., Ltd., (primary particle size: 0.7μm) Silica: trade name “SFP-30M”, made by Denki Kagaku Kogyo K. K., (primary particle size: 0.54 μm)

<Platy, Fibrous or Spherical Filler (C) Having an Average Size of 20 to 300 μm>

As a platy, fibrous or spherical filler having an average size of 20 to 300 μm, the following filler was prepared. The number-average particle size and the number-average fiber length described in ( ) described below were indicated as numerical values before the filler was melted and kneaded with a liquid crystal polyester resin. Talc: trade name “MS-KY”, made by Nippon Talc Co., Ltd., (number-average particle size: 23 μm) Mica: trade name “AB-25S”, made by Yamaguchi Mica Co., Ltd., (number-average particle size: 22 μm) Glass fiber: trade name “PX-1”, made by Owens Coming Corp., (number-average fiber length: 3 mm) Carbon fiber: trade name “XN-100-15M”, made by Nippon Graphite Fiber Corp., (number-average fiber length: 0.15 mm) Silica: trade name “FB-950”, made by Denki Kagaku Kogyo K. K., (average particle size: 23.3 μm) Glass balloons: trade name “S-60HS”, made by Sumitomo 3M Ltd., (average particle size: 30 μm)

<Production of Resin Compositions>

(Example 1)

57.0 parts by mass of the whole aromatic thermotropic liquid crystal polyester (I) was previously mixed with 40.0 parts by mass of the titanium oxide particle and 3.0 parts by mass of the talc by using a ribbon blender; and the mixture was dried at 150° C. for 2 hours in an air oven. The dried mixture was melted and kneaded using a twin-screw extruder (KTX-46, made by KOBE Steel, Ltd.) of which the maximum temperature of the cylinder was set at 380° C., at an extrusion rate of 180 kg/hr to obtain a pellet of a whole aromatic thermotropic liquid crystal polyester resin composition.

(Example 2)

A pellet of a whole aromatic thermotropic liquid crystal polyester resin composition was obtained by the same facility and operational method as in Example 1, except for using the whole aromatic thermotropic liquid crystal polyester (II) in place of the whole aromatic thermotropic liquid crystal polyester (I), and mixing each component so as to have a composition shown in Table 1.

(Examples 3 to 6 and 8 to 15)

Pellets of respective whole aromatic thermotropic liquid crystal polyester resin compositions were obtained by the same facility and operational method as in Example 1, except for mixing each component so as to have respective compositions (the compositions in table were indicated in terms of parts by mass) shown in Table 1.

(Example 7)

57.0 parts by mass of the whole aromatic thermotropic liquid crystal polyester (I) was blended with 40.0 parts by mass of the titanium oxide particle; and a dried mixture was obtained by the same facility and operational method as in Example 1. The mixture was fed to a hopper of a twin-screw extruder (KTX-46, made by KOBE Steel, Ltd.) of which the maximum temperature of the cylinder was set at 380° C.; and a feeder was adjusted to feed (side feed) 3.0 parts by mass of the glass balloons to a midway of the cylinder of the twin-screw extruder; and the mixture was melted and kneaded at an extrusion rate of 180 kg/hr to obtain a pellet of a whole aromatic thermotropic liquid crystal polyester resin composition.

(Comparative Examples 1 to 8)

Pellets of respective whole aromatic thermotropic liquid crystal polyester resin compositions were obtained by the same facility and operational method as in Example 1, except for mixing each component so as to have respective compositions (the compositions in table were indicated in terms of parts by mass) shown in Table 1.

<Measurement of an Average Size of the (C) Component in a Pellet>

The average size of the (C) component in a pellet of a liquid crystal polyester resin composition obtained in Examples and Comparative Examples was measured according to the following method. The results are shown in Tables 2 and 3.

[Measuring Method of a Number-Average Particle Size or a Number-Average Fiber Length]

About 5 g of a composition pellet was ashed in a crucible, and thereafter, 100 mg of an ash content was sampled out of the remaining ash content, and dispersed in 100 cc of soap water. One or two drops of the dispersion liquid were placed on a slide glass using a dropping pipette, and observed under a microscope and photographed. The measurement of a particle size or a fiber length of an object taken on the photograph was carried out for 500 particles or fibers, and the number-average value thereof of the object was determined.

The pellets of the liquid crystal polyester resin compositions obtained in Examples and Comparative Examples were measured or evaluated for the melt viscosity, the productivity, and the moldability, the drooling and the mold blisters at injection molding by the following methods. The results are shown in Tables 2 and 3.

[Measurement of a Melt Viscosity]

An apparent viscosity of a liquid crystal polyester resin composition was defined as a melt viscosity thereof. The melt viscosity was measured using a capillary rheometer (model: 2010, made by INTESCO Co., Ltd.) using a capillary of 1.00 mm in diameter, 40 mm in length and 90° in inflow angle, and at a shear rate of 100 sec⁻¹ under a constant-rate heating at a temperature-rise rate of +4° C./min from 300° C. For a resin composition containing the whole aromatic thermotropic liquid crystal polyester (I), an apparent viscosity at 370° C. was determined, and defined as a melt viscosity; and for a resin composition containing the whole aromatic thermotropic liquid crystal polyester (II), at 340° C. In the measurement, the resin composition was previously dried in a vacuum drier at 150° C. for 4 hours.

[Evaluation of the Productivity]

The productivity of a liquid crystal polyester resin composition in Examples and Comparative Examples was evaluated according to the following standard.

“A”: pellets were obtained.

“C”: strand disorder occurred and pellets could not be produced stably.

[Evaluation of the Moldability]

From pellets of each resin composition obtained in Examples and Comparative Examples, a circular LED reflector was molded which used a gate cross-sectional area of 0.07 mm² and having an opening outer size of 6 mmφ, an opening inner size of 4 mmφ, a height of 1.6 mm and a bottom resin thickness of 0.4 mm, by using an injection molding machine (SG-25, made by Sumitomo Heavy Industries, Ltd.) at a maximum temperature of the cylinder of 350° C., an injection speed of 100 mm/sec, and a mold temperature of 80° C. At this time, the case where molding could be done was evaluated as “A”; and the case where short shot occurred was evaluated as “C”.

[Evaluation of Drooling]

From pellets of each resin composition obtained in Examples and

Comparative Examples, a circular LED reflector was molded which used a gate cross-sectional area of 0.07 mm² and having an opening outer size of 6 mmφ, an opening inner size of 4 mmφ, a height of 1.6 mm and a bottom resin thickness of 0.4 mm, by using an injection molding machine (SG-25, made by Sumitomo Heavy Industries, Ltd.) at a maximum temperature of the cylinder of 350° C., a nozzle temperature of 350° C., an injection speed of 100 mm/sec, and a mold temperature of 80° C. At this time, the case where drooling occurred was evaluated as “C”; and the case where no drooling occurred was evaluated as “A”.

[Evaluation Test of Mold Blisters]

From pellets of each resin composition obtained in Examples and Comparative Examples, a circular LED reflector was molded which used a gate cross-sectional area of 0.07 mm² and having an opening outer size of 6 mmφ, an opening inner size of 4 mmφ, a height of 1.6 mm and a bottom resin thickness of 0.4 mm, by using an injection molding machine (SG-25, made by Sumitomo Heavy Industries, Ltd.) at a maximum temperature of the cylinder of 350° C., an injection speed of 100 mm/sec, and a mold temperature of 80° C. At this time, the presence/absence of occurrence of mold blisters on the surface of the molded article was visually examined, and the case where mold blisters occurred was evaluated as “C”; and the case where no mold blisters occurred was evaluated as “A”.

Injection molded bodies obtained from pellets of each liquid crystal polyester resin composition obtained in Examples and Comparative Examples were further evaluated for the Izod impact strength, the deflection temperature under load (DTUL), the bending strength and the bending elastic modulus. The results are shown in Tables 2 and 3.

(Fabrication of Test Pieces)

From pellets of each resin composition obtained in Examples and Comparative Examples, injection molded bodies of 13 mm (width)×130 mm (length)×3 mm (thickness) were fabricated by injection molding using an injection molding machine (SG-25, made by Sumitomo Heavy Industries, Ltd.) at a maximum temperature of the cylinder of 350° C., an injection speed of 100 mm/sec, and a mold temperature of 80° C.; and these injection molded bodies were used as test pieces for the Izod impact strength test, the DTUL and the bending test.

[Izod Impact Test]

Each test piece obtained above was measured according to ASTM D256 with no notch, and an Izod impact strength was calculated as an average of ten measurements.

[Deflection Temperature Under Load (DTUL)]

Each test piece obtained above was measured according to ASTM D648.

[Bending Strength and Bending Elastic Modulus]

Each test piece obtained above was measured according to ASTM D790.

TABLE 1

| | | | Powder Having a Primary Particle | | | | Filler Having an Average Size | | | | | |
|---|---|---|---|---|---|---|---|---|---|---|---|---|
| | Liquid Crystal | | size of 0.1 to 1 μm (B) | | | | of 20 to 300 μm (C) | | | | | |
| | Polyester (A) | | Titanium | Barium | | Barium | | | Glass | Carbon | | Glass |
| | LCP (I) | LCP (II) | Oxide | Sulfate | Silica | Titanate | Talc | Mica | Fiber | Fiber | Silica | Balloons |
| Example 1 | 57.0 | | 40.0 | | | | 3.0 | | | | | |
| Example 2 | | 57.0 | 40.0 | | | | 3.0 | | | | | |
| Example 3 | 57.0 | | | 40.0 | | | | 3.0 | | | | |
| Example 4 | 57.0 | | | | 40.0 | | | | 3.0 | | | |
| Example 5 | 57.0 | | | | | 40.0 | | | | 3.0 | | |
| Example 6 | 57.0 | | 40.0 | | | | | | | | 3.0 | |
| Example 7 | 57.0 | | 40.0 | | | | | | | | | 3.0 |
| Example 8 | 50.0 | | 35.0 | | | | 15.0 | | | | | |
| Example 9 | 50.0 | | 49.0 | | | | | | 1.0 | | | |
| Example 10 | 40.0 | | 55.0 | | | | 5.0 | | | | | |
| Example 11 | 70.0 | | 29.0 | | | | | | 1.0 | | | |
| Example 12 | 57.0 | | 40.0 | | | | | | 3.0 | | | |
| Example 13 | 55.0 | | 40.0 | | | | | | 5.0 | | | |
| Example 14 | 47.0 | | 50.0 | | | | | | 3.0 | | | |
| Example 15 | 45.0 | | 50.0 | | | | | | 5.0 | | | |
| Comp. Ex. 1 | 60.0 | | 40.0 | | | | | | | | | |
| Comp. Ex. 2 | 60.0 | | | 40.0 | | | | | | | | |
| Comp. Ex. 3 | 60.0 | | | | 40.0 | | | | | | | |
| Comp. Ex. 4 | 80.0 | | 17.0 | | | | 3.0 | | | | | |
| Comp. Ex. 5 | 35.0 | | 55.0 | | | | | | 10.0 | | | |
| Comp. Ex. 6 | 55.0 | | 25.0 | | | | | | 20.0 | | | |
| Comp. Ex. 7 | 69.5 | | | 30.0 | | | 0.5 | | | | | |
| Comp. Ex. 8 | 50.0 | | | | | | 50.0 | | | | | |

Unit in Table: parts by mass

TABLE 2

| | | Number- | | | | | | | | |
|---|---|---|---|---|---|---|---|---|---|---|
| | | Average | | | | | | | | |
| | | Particle size or | | | | | | | | |
| | | Average Fiber | | | | | | | | Bending |
| | | Length of (C) | Melt | | | | Izod Impact | | Bending | Elastic |
| | | Component | Viscosity | | Mold | | Strength | DTUL | Strength | Modulus |
| | Productivity | (μm) | (Pa · s) | Moldability | Blister | Drooling | (kJ/m²) | (° C.) | (GPa) | (GPa) |
| Example 1 | A | 20 | 150 | A | A | A | 46 | 230 | 125 | 10.0 |
| Example 2 | A | 20 | 145 | A | A | A | 45 | 195 | 125 | 9.9 |
| Example 3 | A | 20 | 140 | A | A | A | 42 | 231 | 124 | 10.2 |
| Example 4 | A | 280 | 155 | A | A | A | 40 | 258 | 153 | 13.3 |
| Example 5 | A | 70 | 170 | A | A | A | 55 | 260 | 165 | 15.0 |
| Example 6 | A | 23 | 156 | A | A | A | 80 | 232 | 130 | 10.3 |
| Example 7 | A | 30 | 160 | A | A | A | 47 | 231 | 122 | 9.8 |
| Example 8 | A | 20 | 120 | A | A | A | 42 | 235 | 129 | 10.3 |
| Example 9 | A | 180 | 133 | A | A | A | 57 | 235 | 130 | 11.0 |
| Example 10 | A | 20 | 180 | A | A | A | 60 | 231 | 120 | 9.8 |
| Example 11 | A | 220 | 110 | A | A | A | 45 | 238 | 142 | 12.4 |
| Example 12 | A | 270 | 150 | A | A | A | 45 | 260 | 150 | 13.5 |
| Example 13 | A | 265 | 160 | A | A | A | 37 | 265 | 152 | 13.8 |
| Example 14 | A | 250 | 160 | A | A | A | 35 | 255 | 140 | 11.5 |
| Example 15 | A | 250 | 170 | A | A | A | 30 | 258 | 141 | 11.5 |

TABLE 3

| | | Number- | | | | | | | | |
|---|---|---|---|---|---|---|---|---|---|---|
| | | Average | | | | | | | | |
| | | Particle size or | | | | | | | | |
| | | Average Fiber | | | | | | | | Bending |
| | | Length of (C) | Melt | | | | Izod Impact | | Bending | Elastic |
| | | Component | Viscosity | | Mold | | Strength | DTUL | Strength | Modulus |
| | Productivity | (μm) | (Pa · s) | Moldability | Blister | Drooling | (kJ/m²) | (° C.) | (GPa) | (GPa) |
| Comparative | A | — | 81 | A | C | C | 63 | 225 | 127 | 10.0 |
| Example 1 | | | | | | | | | | |
| Comparative | A | — | 73 | A | C | C | 43 | 228 | 131 | 10.1 |
| Example 2 | | | | | | | | | | |
| Comparative | A | — | 75 | A | C | C | 57 | 228 | 130 | 10.4 |
| Example 3 | | | | | | | | | | |
| Comparative | A | 20 | 90 | A | A | C | 43 | 230 | 138 | 11.9 |
| Example 4 | | | | | | | | | | |
| Comparative | C | — | — | — | — | — | — | — | — | — |
| Example 5 | | | | | | | | | | |
| Comparative | A | 190 | 240 | C | — | A | 28 | 268 | 142 | 14.5 |
| Example 6 | | | | | | | | | | |
| Comparative | A | 22 | 93 | A | C | C | 42 | 233 | 131 | 11.0 |
| Example 7 | | | | | | | | | | |
| Comparative | A | 20 | 180 | C | C | A | 38 | 245 | 100 | 10.0 |
| Example 8 | | | | | | | | | | |

As shown in Table 2, the cases where the pellets of the resin compositions in Examples 1 to 15 were injection molded using a gate cross-sectional area of 0.07 m², neither drooling nor mold blisters occurred, and the moldability of small-thickness molded bodies of 0.5 mm in thickness was proved to be good. The obtained molded bodies had a high impact strength of 30 kJ/m² or higher, and also sufficiently high DTUL, bending strength and bending elastic modulus; it was thus confirmed that mechanical strengths excellent as electric and electronic precision parts can be provided.

By contrast, as shown in Table 3, the cases where the pellets of the resin compositions in Comparative Examples 1 to 3, which contained no (C) component blended, were injection molded caused occurrence of drooling and also occurrence of mold blisters. The case where the pellet of the resin composition in Comparative Example 4, which had a content of a liquid crystal polyester (A) exceeding the upper limit value according to the present invention, was injection molded, contained a large amount of the liquid crystal polyester in the composition, and caused occurrence of drooling. Comparative Example 5, which had a content of a liquid crystal polyester (A) of lower than the lower limit value according to the present invention, exhibited poor productivity of the resin composition, and caused strand disorder, disabling stable production. The case where the pellet of the resin composition in Comparative Example 6, which had a content of (B) component of lower than 29.0 parts by mass and a content of (C) component exceeding 15.0 parts by mass, was injection molded, exhibited poor moldability because the melt viscosity of the resin composition became high, and had a low Izod impact strength of a molded body, exhibiting an inferior mechanical strength. The case where the pellet of the resin composition in Comparative Example 7, which had a content of (C) component of lower than 1.0 part by mass, was injection molded, could not suppress drooling and mold blisters.

The case where the pellet of the resin composition in Comparative Example 8, which contained no (B) component blended, and had a content of (C) component exceeding 15.0 parts by mass, was injection molded, exhibited poor small-thickness moldability and caused occurrence of mold blisters.

### Industrial Applicability

The present invention can provide a method for molding suppressing occurrence of drooling and mold blisters at injection molding using a small gate cross-sectional area while holding excellent moldability and heat resistance of a liquid crystal polyester, and providing a molded body excellent in mechanical strengths such as Izod impact strength.

1. A method for molding a liquid crystal polyester resin composition, comprising: molding the liquid crystal polyester resin composition by injection molding wherein the resin composition is passed through a gate having a cross-sectional area of 0.05 to 1.00 mm², the resin composition comprising 40.0 to 70.0 parts by mass of a liquid crystal polyester (A), 29.0 to 55.0 parts by mass of an indeterminate or spherical powder (B) having a primary particle size of 0.1 to 1 um, and 1.0 to 15.0 parts by mass of a platy, fibrous or spherical filler (C) having an average size of 20 to 300 μm, with respect to 100 parts by mass of the total amount of the resin composition.

2. The method according to claim 1, wherein the (B) component is at least one selected from the group consisting of titanium oxide, barium sulfate, zinc oxide, silica and barium titanate.

3. The method according to claim 1, wherein the (C) component is at least one selected from the group consisting of talc, mica, glass fiber, carbon fiber, silica and glass balloons.

4. The method according to claim 1, wherein the (A) component is a whole aromatic thermotropic liquid crystal polyester having a melting point of 320° C. or higher.

5. The method according to claim 1, wherein the method molds a thin molded article having a portion having a minimum thickness of smaller than 0.5 mm.

6. The method according to claim 1, wherein the method molds an LED reflector.

7. A molded body, obtained by a method for molding a liquid crystal polyester resin composition according to claim 1.
